(19) United States
(12) Patent Application Publication
(10) Pub. No.: US 2006/0121868 A1
(43) Pub. Date: Jun. 8, 2006

(54) On-vehicle radio receiving device, method and program

(75) Inventor: Osamu Jutori, Nishio-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/288,168

(22) Filed: Nov. 29, 2005

(30) Foreign Application Priority Data
Dec. 2, 2004 (JP) 2004-349928

(51) Int. Cl. H04B 1/06

(52) U.S. Cl. 455/238.1

(57) ABSTRACT

An on-vehicle radio receiving device controls the timing of searching for channel reception levels by switching among plural channels. The on-vehicle radio receiving device has a search control function for causing a radio circuit to successively search for reception levels of plural channels, and a data reception control function for causing the radio circuit to receive data by radio over one of the plural channels based on the reception level of each channel as a result of the search. It increases the operation frequency of the search control function as a travel speed of the vehicle increases, and decreases the operation frequency of the search control function as the travel speed of the vehicle decreases.

### CROSS REFERENCE TO RELATED APPLICATION

This application is based on and incorporates herein by reference Japanese Patent Application No. 2004-349928 filed on Dec. 2, 2004.

### FIELD OF THE INVENTION

The present invention relates to an on-vehicle radio receiving device, method and program for performing radio reception by switching among plural radio channels.

### BACKGROUND OF THE INVENTION

Recently, systems are practically implemented which transmit traffic information such as traffic congestion information and road regulation information to on-vehicle radio receiving devices as radio waves of frequency-modulated (FM) broadcasting. Examples of such a system are a vehicle information and communication system (VICS) and a radio data system-traffic message channel (RDS-TMC).

In an on-vehicle radio receiving device in such a system, as the position of a vehicle changes, the level (strength, power, etc.) of a radio wave received from an FM broadcasting station also changes. When the reception level of a channel corresponding to an FM station from which a radio wave is presently being received drops below a given level as a result of travel of the vehicle, the on-vehicle radio receiving device must switch to a channel for another broadcasting station that has a higher reception level.

JP-3391112 proposes a technology for smoothly performing such channel switching as a result of movement of a radio receiving device. This radio receiving device in advance creates a list of alternative FM stations by always searching for the reception levels of FM stations other than an FM station from which data is presently being received.

However, when a radio receiving device that performs reception by switching among plural radio channels by a single tuner performs a search, reception over a current channel must be temporarily stopped to perform the search. As a result, very frequent searches will cause shortage of time available for data reception. Moreover, for example, when a vehicle travels frequently among plural receivable FM stations, less frequent search will disable smooth channel switching corresponding to changes in reception level caused by the movement.

The above too frequent channel search will cause shortage of actual reception time, and conversely, too less frequent channel search will disable smooth response to changes in reception level caused by movement. This will arise in not only FM receiving devices but also in general radio receiving devices capable of reception by switching among plural channels, such as CDMA.

### SUMMARY OF THE INVENTION

The present invention has its object to control search timing in an on-vehicle radio receiving device capable of reception by switching among plural channels.

According to the present invention, a vehicle travel condition is detected and radio reception level search timing is controlled variably in accordance with the detected vehicle travel condition. That is, the number of times of searching is increased as a vehicle travels at higher speeds. As a result, even when a vehicle travels at high speeds in an area, in which many broadcasting stations (radio reception channels) such as RDS-TMC are located, most appropriate one will be searched and selected.

More specifically, according to one aspect, an on-vehicle radio receiving device including a radio circuit capable of radio reception by switching among plural channels has the following functions: calculating a travel speed of a vehicle; causing the radio circuit successively search for reception levels of the plural channels; and causing the radio circuit receive data by radio over one of the plural channels based on the reception level of each channel as a result of the search. Moreover, the on-vehicle radio receiving device changes the number of times of control that temporarily stops the operation of the data reception function to operate the search control function, based on a calculated travel speed of the vehicle. The on-vehicle radio receiving device thus can control changes in search timing according to the travel speed of the vehicle.

As the control based on vehicle speed, the number of times of operations of the search control function may be increased as a calculated travel speed of the vehicle increases, and the number of times of operations of the search control function may be decreased as a calculated travel speed of the vehicle decreases. By this mechanism, when the vehicle speed is high, that is, when the reception level of radio waves changes rapidly, the number of times of search is increased to respond quickly to a change in reception level, while, when the vehicle speed is low, that is, the reception level of radio waves changes slowly, the number of times of search is decreased to increase time usable for data reception.

When the vehicle stops, the reception level of each channel changes little. Therefore, the on-vehicle radio receiving device may prohibit the operation of the search control function when the calculated travel speed of the vehicle is zero. Thus, when the vehicle stops, time for data reception can be maximized. A speed of zero includes not only an exact zero but also a travel speed of nonzero (e.g., 0.1 km per hour) when the vehicle is substantially not traveling.

The on-vehicle radio receiving device may change the number of times of control that stops the operation of the data reception control function to operate the search control function according to which of plural speed ranges a calculated travel speed of the vehicle belongs to. Thus, the number of times of search can be controlled in stages.

The on-vehicle radio receiving device calculates an average travel speed in a past period of the vehicle, and may change the number of times of control that temporarily stops the operation of the data reception function to operate the search control function, based on the calculated average travel speed.

When a travel speed that the number of times of change depends on is averaged to an average speed, a sudden change in the number of times of search due to an instantaneous change in speed such as a search prohibited because of an instantaneous stop can be prevented. For example, in the case where a search is prohibited when an average vehicle speed is zero, when a past period for taking an average is a period (e.g., three minutes) longer than a maximum time (e.g., two seconds and 30 seconds) required for a wait for a signal to change, it is impossible that a search is prohibited for the reason that vehicle speed is zero in a temporary stop state such as a wait for a signal to change.

In the search control function, the on-vehicle radio receiving device may successively search for the reception levels of channels in a partial channel range in the above plural channels, then terminate the operation. Moreover, the extent of the partial channel range may change depending on a travel speed of the vehicle. Thus, control of search time can be performed more finely based on a vehicle speed.

The extent of the channel range may be any thing that reflects a quantitative extent of channel range, such as the extent of bandwidth of frequencies within the channel range and the number of channels within the channel range.

According to another aspect, an on-vehicle radio receiving device including a radio circuit capable of radio reception by switching among plural channels that has the following functions: calculating a distance of the vehicle; causing the radio circuit successively search for reception levels of the plural channels; and causing the radio circuit receive data by radio over one of the plural channels based on the reception level of each channel as a result of the search of the search control function. Moreover, in timing repeated when a distance of the vehicle calculated by the distance calculating means increases to a reference distance, the data reception control function stops its operation, and the search control function starts its operation.

Thus, the on-vehicle radio receiving device repeatedly performs a search in repetitive timings based on distance of the vehicle. Since a reception level for each channel changes mainly with movement of a vehicle, repetitive timings of search are based on distances of the vehicle. Therefore, a search is performed in timing corresponding to the degree of a change in reception levels for each channel. Thus, the on-vehicle radio receiving device can control changes of search timing in a form corresponding to the degree of a change in reception levels.

In the timing when a wait time has elapsed after an increase in the calculated distance of the vehicle reaches a reference distance, the data reception control function may stop its operation and the search control function may start its operation. Thus, even when a distance of the vehicle reaches a reference distance, a wait time is required until a succeeding search begins. It is therefore reduced that a vehicle travels very fast and the number of times of search becomes tremendous, with the result that time for data reception falls into shortage.

The wait time may be a maximum time necessary for a transmitting station of data received by the on-vehicle radio receiving device to transmit one unit of data, that is, a maximum cycle of data repetitive transmission. By this mechanism, even when the vehicle travels fast, data reception continues until at least one unit of the data can be received.

A reference distance on which stop of the operation of the data reception control function and start of the operation of the search control function depend may be longer when the vehicle is traveling on an expressway, in comparison with when the vehicle is traveling on an ordinary road. Thus, it can be reduced that excessive repetition of search on an expressway causes shortage of data reception time.

The on-vehicle radio receiving device has a function for calculating a travel speed of the vehicle, and a reference distance on which stop of the operation of the data reception control function and start of the operation of the search control function depend may be longer when a calculated travel speed of the vehicle is higher. Thus, it can be reduced that excessive repetition of search during high speed traveling causes shortage of data reception time.

The on-vehicle radio receiving device may continue actuating the data reception control function at all times when the calculated travel speed of the vehicle is zero. Thus, time for data reception can be maximized while the vehicle stop.

### BRIEF DESCRIPTION OF THE DRAWINGS

The above and other objects, features and advantages of the present invention will become more apparent from the following detailed description made with reference to the accompanying drawings. In the drawings:

FIG. 1 is a circuit diagram showing an on-vehicle radio receiving device according to a first embodiment of the present invention;

FIG. 2 is a flowchart showing a first program executed in the first embodiment;

FIG. 3 is a flowchart showing a second program executed in the first embodiment;

FIG. 4 is an operation diagram showing timing of data reception and search in the first embodiment; and

FIG. 5 is a flowchart showing a program executed in a second embodiment of the present invention.

### DETAILED DESCRIPTION OF THE PREFERRED EMBODIMENTS

### First Embodiment

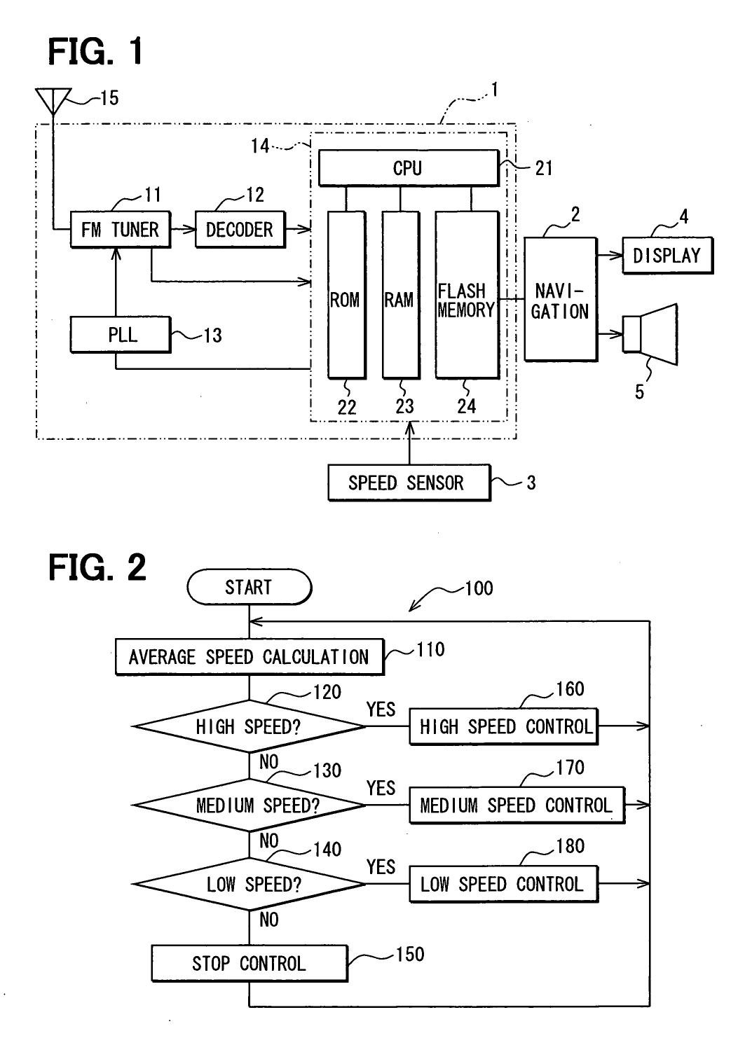

Referring to FIG. 1, an on-vehicle radio receiving device 1 is provided to receive data of traffic information (e.g., accident information, road regulation information, etc.) contained in a frequency-modulated (FM) radio wave transmitted from an FM broadcasting station and output the received data to a navigation device 2 in the vehicle. Systems that exchanges traffic information by using FM radio waves may include a vehicle information and communication system (VICS) and a radio data system-traffic message channel (RDS-TMC). Since such broadcasting stations of FM radio wave are located in different positions, a change in the position of a vehicle equipped with the on-vehicle radio receiving device 1 causes a change in the level of radio wave received from the broadcasting stations. As a result, the radio wave of a channel that could be received in a certain position may not be received in a different position, and the radio wave of a channel that could not be received in a certain position may be received in a different position.

The navigation device 2 displays a route from a present position of a vehicle to a specified destination on a map. The car navigation device 2 determines the present position of the vehicle from signals and the like from a geomagnetic sensor, a gyroscope, a vehicle travel speed sensor, and a global positioning system (GPS) receiver which are well-known, calculates an optimal route to the destination inputted in the determined present position, and displays an image of the calculated optimum route in a display unit 4. The navigation device 2 outputs guidance voice to a loudspeaker 5 to indicate a turning direction and the like in intersections and other places in the optimal route. The navigation device 2 receives data of traffic information from the on-vehicle radio receiving device 1, and uses data of the reception result to calculate the guidance route or displays it in the display unit 4.

A vehicle speed sensor 3 outputs a vehicle speed signal based on the rotation speed and the like of wheels.

The on-vehicle radio receiving device 1 includes an FM tuner 11, a decoder 12, a phase lock loop (PLL) circuit 13, an electronic control unit 14, and an antenna 15. The FM tuner 11, the decoder 12 and the PLL circuit 13 form a radio circuit.

The FM tuner 11 takes out data in a radio wave signal of a frequency corresponding to a control voltage from the PLL circuit 13 from the radio wave received by the antenna 15 and outputs it to the decoder 12. The FM tuner 11 outputs a reception level (strength, power, etc.) value of the received radio wave signal to the control unit 14.

The decoder 12 decodes the data received from the FM tuner 11 according to the standards of systems such as VICS and RDS-TMS, and outputs traffic information data obtained as a result of the decoding to the control unit 14.

The PLL circuit 13 outputs a control voltage based on a command specifying a reception frequency, received from the control unit 14, to the FM tuner 11.

The control unit 14 includes a CPU 21, a ROM 22, a RAM 23 and a flash memory 24. The CPU 21 executes various programs stored in the ROM 22. During program execution, the CPU 21 reads out data from the ROM 22, the RAM 23 and the flash memory 24, writes data to the RAM 23 and the flash memory 24, receives a radio wave signal reception level value from the FM tuner 11, receives data of traffic information from the decoder 12, outputs a command specifying a radio wave signal reception frequency to the PLL circuit 13, receives a vehicle speed signal from the vehicle speed sensor 3 as a vehicle travel condition signal and outputs data of traffic information to the navigation device 2.

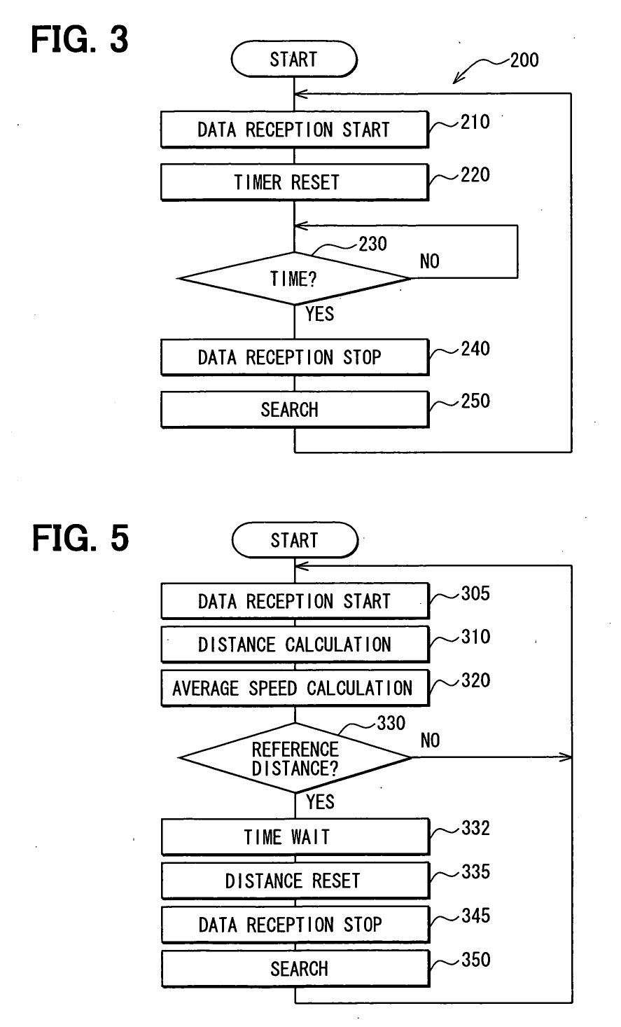

The CPU 21 is programmed to execute the first and the second programs 100 and 200 shown in FIGS. 2 and 3, which are parts of programs executed by the CPU 21. The programs 100 and 200 are for controlling the reception of and a search for traffic information via the FM tuner 11 and the decoder 12.

The search is a process of successively detecting the reception levels and the contents of reception data of plural channels in an FM receivable frequency band, preparing a list consisting of channels for transmitting presently receivable traffic information and reception levels of the channels, arranged in descending order by reception level and storing it in the flash memory 24. Tuning a frequency to a channel targeted for reception level detection during search is achieved by outputting a command specifying the frequency of the channel to the PLL circuit 13. The value of a reception level is determined by a reception level value received from the FM tuner 11. Whether a channel under reception is a channel for transmitting traffic information is determined from the contents of data received from decoder 12.

In the reception of traffic information data, the CPU 21 outputs a command specifying the frequency of a relevant channel in an order specified in a list stored in the flash memory 24 by search, that is, in descending order of reception level, to the PLL circuit 13. The first time that the FM tuner 11 and the decoder 12 have become capable of receiving traffic information, the CPU 21 maintains the reception frequency, receives traffic information data from the decoder 12 and outputs the traffic information data to the navigation device 2.

Referring to FIG. 2, the CPU 21 starts the execution of the first program 100 immediately after an engine of the vehicle is started.

At step 110, the CPU 21 calculates the average speed of an the vehicle. At step 120, it determines whether the average speed is high. When it is not high, at step 130, it determines whether the average speed is medium. When it is not medium, at step 140, it determines whether the average speed is low.

More specifically, the average speed of the vehicle is an average speed between the present and a time preceding by a prescribed period. The prescribed period may be a period (e.g., 3 minutes) longer than a maximum time (e.g., two minutes and 30 seconds) required for a wait for a traffic signal light to change. By this arrangement, the average vehicle speed will not become zero even when a vehicle stop state occurs due to a wait for the traffic signal light to change. An average vehicle speed becomes zero when the vehicle does not move for the above period and longer due to traffic congestion or for other reasons.

An average vehicle speed of 100 km or faster per hour may be defined as a high speed, the average vehicle speed from 50 km to less than 100 km per hour may be defined as the medium speed, and the average vehicle speed from 0.1 km to less than 50 km per hour may be defined as the low speed.

When the average vehicle speed is determined as the high speed at step 120, high speed control is performed at step 160. In the high speed control, a reception period length in the flash memory 24 is set to a first value.

When the average vehicle speed is determined as the medium speed at step 130, medium speed control is performed at step 170. In the medium speed control, the reception period length in the flash memory 24 is set to a second value.

When the average vehicle speed is determined as the low speed at step 140, low speed control is performed at step 180. In the low speed control, the reception period length in the flash memory 24 is set to a third value.

When the average vehicle speed is not any of high speed, medium speed and low speed, that is, when the vehicle substantially stops, at step 150, stop control is performed. In the stop control, the reception period length in the flash memory 24 is set to a fourth value.

The data reception period length refers to a variable indicating the length of a period during which data reception is continuously performed. Values set in the reception period length variable have the following relation:

first value<second value<third value<fourth value. More specifically, the first value may be 2.5 minutes, the second value may be six minutes and the third value may be 13 minutes. The fourth value may be 30 minutes or may be a larger value (e.g., 24 hours) in comparison with search time. Adopting such a very large value as the fourth value in comparison with the search time virtually prohibits search and continues data reception all the time.

The first value, 2.5 minutes, is a value as an example of a maximum repetition cycle of transmission data from the FM broadcasting station. The FM broadcasting station periodically repeats traffic information. Therefore, when the on-vehicle radio receiving device 1 continues data reception for the longest time of the repetition cycle, one cycle of traffic information can be received almost without fail for one data reception.

The CPU 21 executes step 110 again after steps 150 to 180. By repeatedly executing steps 110-180, the CPU 21 changes the value of the reception period length according to a change in the average travel speed of the vehicle. Thus, the number of times of search can be increased as the vehicle speed increases.

Referring to FIG. 3, the CPU 21 starts the execution of the second program 200 immediately after the engine is started. The programs 100 and 200 are executed in parallel to each other.

At step 210, the CPU 21 starts the traffic information data reception. With this, the CPU 21 starts to perform processing for the traffic information data reception in parallel with the execution of the program 200.

At step 220, a timer is reset. Specifically, present time is stored in the RAM 23 as the start time data.

At step 230, the CPU 21 waits until the timer counts a specified time period for continuing data reception. This specified period corresponds to the reception period length determined at step 160, 170 or 180 in FIG. 2 and stored in the flash memory 24. When the timer counts the specified period, the CPU 21 executes step 240. Whether the timer finishes time counting is determined from whether a time from the start time data stored in the RAM 23 at step 220 to present time is equal to or greater than the data reception period length stored in the flash memory 24.

At step 240, the CPU 21 stops the traffic information data reception. This terminates the processing for receiving traffic information data that has been performed in parallel.

At step 250, the CPU 21 performs the above search processing. On termination of processing of step 250, it executes step 210 again to start processing for data reception by a channel selected based on the result of the search.

The search performed at step 250 is performed not to detect levels of all channels in an FM frequency band but to detect levels of part of channels. Specifically, in one execution of step 250, when the CPU 21 successively outputs commands specifying the reception frequencies of part of channels to the PLL circuit 13, and terminates checking all of the commands to detect reception levels and determine whether the channel is a channel used for traffic information, processing of step 250 in the execution, that is, processing for the search in the execution is terminated.

In each execution of step 250 repeated by a loop of steps 210 to 250, the CPU 21 circularly changes partial channel ranges targeted for reception level detection in all FM frequency bands. Reception levels of channels in all FM frequency bands are not detected without such plural executions of the search.

The extent (e.g., number of channels, the extent of frequency range, etc.) of a partial channel range targeted for reception level detection in each execution may be always constant, or may be larger as the latest average vehicle speed determined at step 110 of the program 100 becomes higher.

By executing the program 200, the CPU 21 performs data reception for a set data reception period (steps 210 to 230), then temporarily stops the data reception (step 240), immediately thereafter executes a search (step 250), and on termination of the search, starts the data reception again (step 210).

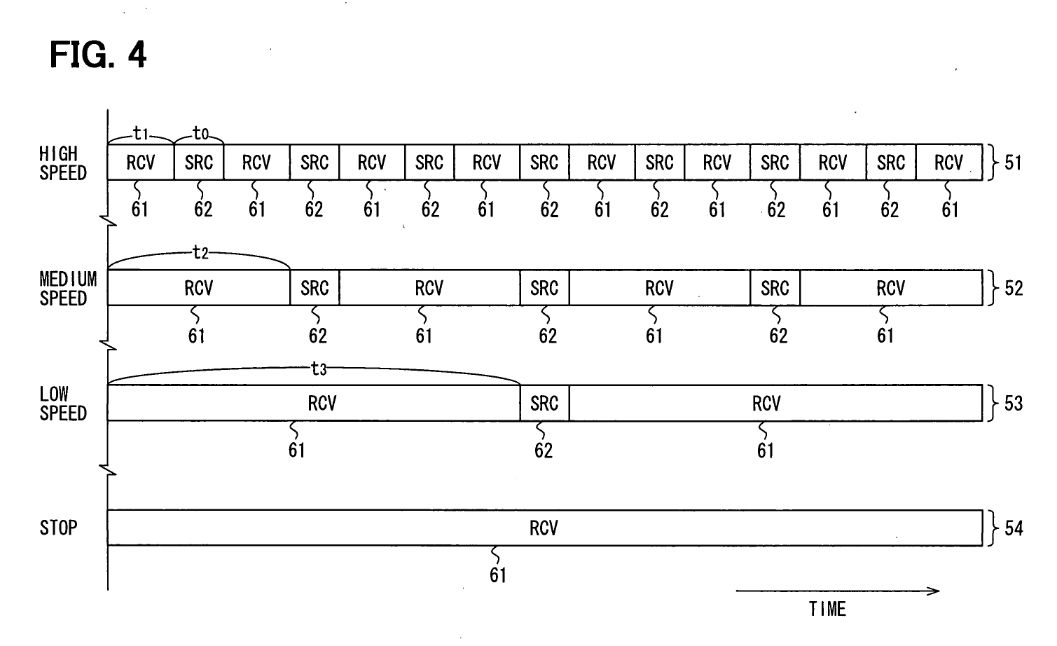

The operation of the first embodiment is shown in FIG. 4 as a time-series distribution of time zones of data reception and search switched according to execution of the programs 100 and 200 by the CPU 21. Four bands 51, 52, 53 and 54 vertically arranged indicate the distributions of time zones of data reception and search at high speed travel, medium speed travel, low speed travel, and stop in that order from top to bottom. The fourth value is considered to be an infinite value.

The length of a section 61 indicating a data reception time zone (RCV) in each band changes according to a vehicle speed. In other words, (length t1 of data reception time zone 61 at high speed traveling)<(length t2 of data reception time zone 61 at medium speed traveling)<(length t3 of data reception time zone 61 at low speed traveling). A data reception time zone 61 at stop has no break. Thus, an increase in the length of one data reception time zone causes a reduction in the number of times of occurrence of search time zones (SRC) 62, and inexistence of a break in data reception time zone 61 inhibits the occurrence of search time zone 62. The on-vehicle radio receiving device 1 changes the frequency of occurrence of search time zones according to vehicle speed by thus changing the length of data reception time zone according to vehicle speed.

The length of search time zone 62 differs depending on the receiver sensitivity of FM transmitting stations in a present position of the vehicle and channels in a search range even when travel speed is the same. The length of search time zone 62 also changes depending on vehicle speed. Specifically, when search times during high speed traveling, medium speed traveling, low speed traveling and stop are assumed to be s1, s2, s3 and s4, respectively, a relation of s1>s2>s3>s4 is satisfied. In other words, the higher is the travel speed of the vehicle, the length of the search time zone 62 is longer. As described above, this is attributed to the fact that the higher is the travel speed of the vehicle, the range of channels targeted for search is larger.

As described above, the on-vehicle radio receiving device 1 increases the number of times of search as the travel speed of the vehicle increases, and decreases the number of times of search as the travel speed of the vehicle decreases. Thus, when the vehicle speed is high, that is, when the reception level of radio waves changes rapidly, the number of times of search is increased to respond quickly to a change in reception level. On the other hand, when the vehicle speed is low, that is, the reception level of radio waves changes slowly, the number of times of search is decreased to increase time usable for data reception.

The on-vehicle radio receiving device 1 changes the number of times of search execution according to which of plural speed ranges high speed, medium speed, low speed and stop the travel speed of the vehicle belongs to. Thus, the number of times of search can be controlled in stages.

The travel speed on which the number of times of search depends is averaged to an average speed, and the period for taking an average is longer than a maximum time required for a wait for a traffic signal light to change. Therefore, it does not arise that no search is performed even if the vehicle speed is zero in a temporary stop state such as a wait for a traffic signal light to change.

Furthermore, the on-vehicle radio receiving device 1 increases the extent of the range of channels targeted for search as the travel speed of the vehicle becomes higher. This will more properly enables quick response to a change in reception level during high speed traveling and the allocation of time for data reception during low speed traveling.

### Second Embodiment

In the second embodiment, the CPU 21 continuously acquires vehicle speed information from the vehicle speed sensor 3 to successively calculate a cumulative distance of the vehicle, based on such information. The CPU 21 controls changes in the number of times of search by executing a program 300 in place of the programs 100 and 200.

Immediately after the engine is started, the CPU 21 starts the execution of the program 300. At step 305, it starts traffic information data reception like step 210 of the program 200. With this reception, the CPU 21 performs processing for traffic information data reception in parallel with the execution of the program 300.

At step 310, it calculates an increase in a distance from a position at a previous search. Specifically, it subtracts a search-time cumulative distance stored in the flash memory 24 from a present cumulative distance of the vehicle, and regards the result as an increase in a distance from the previous search. This travel distance is calculated as a vehicle travel condition.

At step 320, it calculates a present average vehicle speed like step 110 of the program 100. At step 330, it determines whether the increase in distance calculated at step 310 is equal to or greater than a reference distance. When equal to or greater than the reference distance, it executes step 332, and otherwise executes step 305 again.

The reference distance may be a linearly increasing function of the average vehicle speed calculated at step 320. For example, when the average vehicle speed is zero, the reference distance may be 5 kilometers. When the average vehicle speed is 100 kilometers per hour, the reference distance may be ten kilometers. As another example, the reference distance may be a constant value (e.g., ten kilometers).

At step 332, the CPU 21 waits for a predetermined wait time. The wait time is a maximum cycle of repetitive transmission of traffic information data in an FM broadcasting station. The wait time may become larger as a travel speed becomes higher.

After the wait time has elapsed, it resets the distance at step 335. Specifically, it stores the present cumulative distance in the flash memory 24 as a search-time cumulative distance.

At step 345, it stops the data reception like step 240 of the program 200. At step 350, it performs the search like step 250 of the program 200, and after termination of the search, it restarts the data reception at step 305.

Since the search is performed immediately after step 335, the cumulative distance stored in the flash memory 24 at step 335 is substantially equal to a search-time cumulative distance.

By the execution of the program 300, the on-vehicle radio receiving device 1 calculates the distance and average speed of the vehicle (steps 310 and 320). When an increase in the distance from a position at a previous search reaches the reference distance that increases with an increase in the average vehicle speed (step 330), waits for the wait time (step 332). Then, it temporarily stops data reception under execution (step 345), executes the search (step 350), and after termination of the search, restarts the data reception (step 305).

In this way, when the wait time has elapsed after a distance of the vehicle travel reaches the reference distance, the on-vehicle radio receiving device 1 stops data reception and starts the search.

Thus, the on-vehicle radio receiving device 1 repeatedly performs the search in repetitive timings based on travel distances of the vehicle. Since the reception level for each channel changes mainly with movement of a vehicle, repetitive timings of search are based on distances of the vehicle. Therefore, the search is performed in timing corresponding to the degree of a change in the reception levels for each channel. Thus, the on-vehicle radio receiving device 1 can control changes of search timing in the form corresponding to the degree of a change in the reception levels.

Even when the distance of the vehicle reaches the reference distance, the wait time is required until a succeeding search begins. Therefore, for example, it is less likely that a vehicle travels very fast and the number of times of search becomes too large, with the result that time for data reception falls into shortage.

The wait time is a maximum cycle of repetitive transmission of traffic information data in the FM broadcasting station. Thus, since the on-vehicle radio receiving device 1 continues data reception for the longest time of the repetition cycle, one cycle of traffic information can be received almost without fail for one data reception.

Since the reference distance is longer when the calculated travel speed of the vehicle is higher, it is less likely that the excessive repetition of search during high speed traveling causes shortage of data reception time.

### Other Embodiments

In the above embodiments, the on-vehicle radio receiving device 1 changes the number of times of search based on the average speed of the vehicle. However, an instantaneous speed at that time may be used instead of the average speed.

Although the on-vehicle radio receiving device 1 receives data of traffic information in the embodiments, the device 1 may receive any types of data such as character data, image data and moving image data.

The data reception is not limited to FM reception. It may be achieved by any types of channel-classified radio reception such as OFDM-based digital television reception and digital radio reception, CDMA reception, and DSRC reception. Channels targeted for the search may be channels of CDMA spreading code, in addition to channels of frequencies.

Although only part of channels are searched by one search in the embodiments, all channels targeted for reception may be searched each time.

Although the number of times of search changes in stages according to travel speed in the embodiments, it may change smoothly according to the travel speed.

In the second embodiment, the reference distance used for the decision of step 330 changes depending on the average travel speed. However, it may change depending on whether the vehicle is presently traveling on an expressway or ordinary road. Specifically, a reference distance on which stop of data reception and search start depend may be longer when the vehicle is traveling on an expressway, in comparison with when the vehicle is traveling on an ordinary road. Thus, it is less likely that excessive repetition of search on an expressway causes shortage of data reception time.

In this case, whether the road on which the vehicle is traveling is an expressway or an ordinary road may be determined by comparison map data acquired from the navigation device 2 and the present position. Alternatively, an inquiry about whether the road on which the vehicle is traveling is an expressway or an ordinary road may be issued to the navigation device 2, and whether the road on which the vehicle is traveling is an expressway or an ordinary road may be determined from the reply.

In the embodiments, the on-vehicle radio receiving device 1 determines the present position of the vehicle from a signal from the vehicle speed sensor 3. However, the present position of the vehicle may be determined by acquiring present position information of the vehicle from the navigation device 2.

Channels targeted for data reception may be selected not in descending order of reception level but using broadcasting station location information and broadcasting station frequency information that are stored in the navigation device 2. Specifically, when the navigation device 2 guides a route to a destination, it may select a broadcasting station location between the present position of the vehicle and the destination, and the control unit 14 and the PLL circuit 13 may control the FM tuner 11 to receive the frequency of the broadcasting station.

Many other embodiments may be implemented without departing from the spirit of the invention.

What is claimed is:

1. An on-vehicle radio receiving device comprising:
a radio circuit capable of radio reception by switching a channel of radio reception among plural channels;
a travel speed calculating means for calculating a travel speed of a vehicle;
a search control means for causing the radio circuit to successively search for radio reception levels of the plural channels;
a data reception control means for causing the radio circuit to receive data by radio over one of the plural channels determined based on the reception level of each channel as a result of search of the search control means; and
a search time control means for changing, based on the travel speed of the vehicle calculated by the travel speed calculating means, the number of times of control that temporarily stops operation of the data reception control means for execution of a search operation of the search control means.

2. The on-vehicle radio receiving device according to claim 1,
wherein the search time control means increases the number of times of operations of the search control means as the travel speed of the vehicle calculated by the travel speed calculating means increases.

3. The on-vehicle radio receiving device according to claim 1,
wherein the search time control means prohibits the operation of the search control means when the travel speed of the vehicle calculated by the travel speed calculating means is zero.

4. The on-vehicle radio receiving device according to claim 1,
wherein the search time control means changes the number of times of control that stops the operation of the data reception control means according to which of plural speed ranges the travel speed of the vehicle calculated by the travel speed calculating means belongs to, to operate the search control means.

5. The on-vehicle radio receiving device according to claim 1, wherein:
the travel speed calculating means calculates an average travel speed in a predetermined period of the vehicle; and
the search time control means changes the number of times of control that temporarily stops the operation of the data reception control means to operate the search control means, based on the average travel speed calculated by the travel speed calculating means.

6. The on-vehicle radio receiving device according to claim 1, wherein:
the search control means successively searches for the reception levels of channels in a partial channel range in the plural channels; and
extent of the partial channel range changes depending on the travel speed of the vehicle calculated by the travel speed calculating means.

7. An on-vehicle radio receiving device comprising:
a radio circuit capable of radio reception by switching a channel of radio reception among plural channels;
a distance calculating means for calculating a travel distance of a vehicle;
a search control means for causing the radio circuit to successively search for reception levels of the plural channels; and
a data reception control means for causing the radio circuit to receive data by radio over one of the plural channels based on the reception level of each channel as a result of the search of the search control means,
wherein, at timing repeated when the travel distance of the vehicle calculated by the distance calculating means increases to a reference distance, the data reception control means stops an operation thereof and the search control means starts an operation thereof.

8. The on-vehicle radio receiving device according to claim 7,
wherein at timing when a wait time has elapsed after an increase in a travel distance of the vehicle calculated by the distance calculating means reaches a reference distance, the data reception control means stops the operation thereof and the search control means starts the operation thereof.

9. The on-vehicle radio receiving device according to claim 7,
wherein the reference distance on which stop of the operation of the data reception control means and start of the operation of the search control means depend is longer when the vehicle travels on an expressway, in comparison with when the vehicle travels on an ordinary road.

10. The on-vehicle radio receiving device according to claim 7, further comprising:
a travel speed calculating means for calculating a travel speed of the vehicle,
wherein the reference distance on which stop of the operation of the data reception control means and start of the operation of the search control means depend is longer when the travel speed of the vehicle calculated by the travel speed calculating means is higher.

11. The on-vehicle radio receiving device according to claim 7,
wherein the data reception control means continues to operate all times when the travel speed of the vehicle calculated by the travel speed calculating means is zero.

12. A program medium for operating a computer to:
calculate a travel speed of a vehicle;
cause a radio circuit capable of radio reception by switching a channel of radio reception among plural channels to successively search for reception levels of the plural channels;
cause the radio circuit to receive data by radio over one of the plural channels based on the reception level of each channel as a result of the search; and
change, based on the travel speed of the vehicle, the number of times of control that temporarily stops data reception of the radio circuit for starting the search.

13. A program medium for operating a computer to:
calculate a travel distance of a vehicle;
cause a radio circuit capable of radio reception by switching a channel of radio reception among plural channels to successively search for reception levels of the plural channels; and
cause the radio circuit receive data by radio over one of the plural channels based on the reception level of each channel as a result of search,
wherein at timing repeated when the travel distance of the vehicle increases to a reference distance, the data reception is stopped and the search is started.

14. An on-vehicle radio receiving method for a vehicle having a radio circuit, the method comprising steps of:
searching for a radio reception channel through which the radio circuit receives data based on reception levels of plural channels;
receiving the data through the radio reception channel searched by the searching step;
detecting a travel condition of the vehicle; and
controlling search timing, at which the searching step is started by stopping the receiving step, variably based on the detected travel condition so that the number of times of the searching step is increased as a travel speed of the vehicle increases.

15. The on-vehicle radio receiving method according to claim 14, wherein:
the detecting step detects a travel speed of the vehicle as the travel condition; and
the controlling step changes the search timing by shortening a data receiving time length of the receiving step as the travel speed of the vehicle increases.

16. The on-vehicle radio receiving method according to claim 14, wherein:
the detecting step detects a travel distance of the vehicle as the travel condition; and
the controlling step starts the searching step to start radio reception when the detected travel distance reaches a reference distance.

17. The on-vehicle radio receiving method according to claim 16, wherein:
the detecting step further detects a travel speed of the vehicle; and
the controlling step changes the search timing by lengthening the reference distance as the detected travel speed increases.

18. The on-vehicle radio receiving method according to claim 14,
wherein the receiving step continues to receive the data at least for a time length longer than an interval between successive transmission of traffic information from a FM radio broadcasting station.

19. The on-vehicle radio receiving method according to claim 14,
wherein the travel speed of the vehicle is an average of travel speeds for a predetermined period, which is longer than an interval of a change in a traffic signal light.
